(19) United States
(12) Patent Application Publication
(10) Pub. No.: US 2008/0253765 A1
(43) Pub. Date: Oct. 16, 2008

(54) OPTICAL POWER MEASURING APPARATUS AND OPTICAL SIGNAL RECEIVING APPARATUS COMPRISING SAME

(75) Inventors: Kouichi Sugimura, Yokohama-shi (JP); Kiyoshi Yamauchi, Yokohama-shi (JP); Chizuru Yuyama, Yokohama-shi (JP); Tomoya Nakamura, Yokohama-shi (JP); Kenji Sasaki, Yokohama-shi (JP)

Correspondence Address: FISH & RICHARDSON P.C., P.O. BOX 1022, MINNEAPOLIS, MN, 55440-1022, US

(73) Assignees: JACKAL TECHNOLOGIES CORPORATION, Yokohama-shi (JP); LEADER ELECTRONICS COPORATION, Yokohama-shi (JP)

(21) Appl. No.: 12/028,603

(22) Filed: Feb. 8, 2008

(30) Foreign Application Priority Data
Feb. 9, 2007 (JP) 030045/2007

(51) Int. Cl. H04B 10/08; H04B 10/06

(52) U.S. Cl. 398/38; 398/202

(57) ABSTRACT

An optical power measuring apparatus for measuring a power level of an optical signal comprised of a light intensity modulated signal, received by a light receiving element is provided. In the apparatus, a first signal path including a first voltage detection circuit and a first amplifier circuit supplies a processor with a first signal having a voltage proportional to a current flowing through a light receiving element (PD), and a second path including a TIA, a DC detection circuit and a second amplifier circuit supply the processor with a second signal. The second signal corresponding to an envelope of a voltage from the TIA. The processor compares the level of the first signal with a predetermined set value to select an optical power value retrieved based on the first signal when the level of the first signal is equal to or higher than the set value, and to select an optical power value retrieved based on the second signal when lower than the set value, and outputs the selected optical power value as a measured optical power value Pout. An output signal of the TIA can be supplied to an external device, so that the optical power measuring apparatus can measure an optical power level while serving as an optical signal receiving apparatus.

### BACKGROUND OF THE INVENTION

1. Field of the Invention

The present invention relates to an optical power measuring apparatus and an optical signal receiving apparatus comprising the same, and more particularly, to an optical power measuring apparatus which can accurately measure the power of a light intensity modulated signal received at an input port thereof, and an optical signal receiving apparatus comprising the optical power measuring apparatus.

2. Description of the Related Art

In a conventional apparatus for measuring the power of an optical signal, the optical signal is received by a photo-diode (PD), and a current flowing through the PD is detected to find an optical power value corresponding to the current. Japanese Official Gazettes JP2003-322564A and JP7-140001A disclose such optical power measuring apparatuses.

A relatively small dynamic range is a problem inherent to the above conventional approach of detecting a voltage across a current detecting resistor to measure a current which flows through a photo-diode connected to the resistor in series. That is, as can be seen from a graph shown in FIG. 1 which represents the relationship between an amount of optical power (Pin) and an amount of a PD current (I), the optical power amount Pin can be relatively accurately measured in a range in which the input optical power amount Pin is relatively large, because a change ΔI/ΔPin is relatively large and has a substantially linear characteristic in the range. On the contrary, in a range in which the optical power amount Pin is relatively small, even a change in the optical power, if any, would cause an extremely small change in the PD current. Accordingly, in the range in which the optical power is relatively small, the measuring accuracy is lower due to increased errors, resulting in a failure in ensuring a sufficiently wide dynamic range for measuring the optical power.

An optical power meter described in JP2003-322564A comprises a power range switching function for selecting a gain for an amplifier in accordance with the level of received optical power with the intention to extend the dynamic range. However, this power meter requires to include a beam splitter because the power meter is configured to split received light by the beam splitter toward a secondary measuring system which monitors the split light for the optical power level which is relied on to select the gain for the amplifier. In addition, the secondary measuring system requires a light receiver and an optical power measuring function as well.

An optical power measuring apparatus described in JP7-140001A is configured to convert a current flowing through a photo-diode to a voltage by a transimpedance amplifier having a range switching function. Accordingly, since the dynamic range of measurement is extended by controlling the gain of the transimpedance amplifier, this optical power measuring apparatus suffers from a similar problem to the optical power meter described in JP2003-322564A.

In addition, a conventional optical power measuring apparatus exists as a stand-alone measuring apparatus, separately from an optical signal receiving apparatus, i.e., an apparatus for receiving an optical signal, generating an electric signal corresponding to the optical signal, and communicating the electric signal to another apparatus. Therefore, when one attempts to measure the power of an optical signal which is being received by the optical signal receiving apparatus, a part of the optical signal must be extracted by a beam splitter or the like to measure the power intensity of the split partial optical signal. In other words, the optical power is measured based on a smaller part of the optical signal, giving rise of a problem of a lower measuring accuracy. Further, the need for the beam splitter or the like makes it difficult to reduce the size and price of the optical signal receiving apparatus. Particularly, in the case where an optical signal is a light intensity modulated signal, the dynamic range of the signal can largely vary depending on receiving environments. Therefore, it has been desired to provide a small-size and low-price apparatus which can accurately measure the power of a light intensity modulated signal. However, no proposal has been so far made for such an apparatus.

### SUMMARY OF THE INVENTION

The present invention has been made in view of the foregoing problems of the prior arts as described above, and it is a first object of the invention to provide an optical power measuring apparatus which has a wide dynamic range and is configured to measure the optical power of a light intensity modulated signal.

It is a second object of the present invention to provide a small and low-price optical signal receiving apparatus which comprises an optical power measuring apparatus having a wide dynamic range.

To achieve the objects mentioned above, the present invention is based on a main concept that a PD current detection scheme is employed in a range in which an optical signal comprised of a light intensity modulated signal has relatively large power, whereas a waveform DC detection scheme is employed in a range in which the optical signal has relatively small power. Also, the present invention employs an output of a transimpedance amplifier for delivery to the outside of an optical signal receiving apparatus and for power measurement, thereby enabling the optical power measuring apparatus to measure the power of a light intensity modulated signal while receiving the signal.

In a first aspect, the present invention provides an optical power measuring apparatus for measuring a power level of an optical signal comprised of a light intensity modulated signal, received by a light receiving element, wherein the apparatus comprises:

first output means for outputting a first signal having a voltage which is proportional to a current flowing through the light receiving element;

second output means for outputting a second signal having a voltage which is obtained by converting the current flowing through the light receiving element thereto by a transimpedance amplifier;

first processing means for receiving the first signal and calculating an optical power level corresponding to the first signal;

second processing means for receiving the second signal and calculating an optical power level corresponding to the second signal; and

selecting means for receiving the first signal, comparing the level of the first signal with a predetermined set value, and selecting the output of the first processing means when the level of the first signal is equal to or higher than the set value, and the output of the second processing means when the level of the first signal is lower than the set value to output the selected output as a measured optical power value.

Preferably, in the optical power measuring apparatus described above, the selecting means is further adapted to operate the first processing means alone when the level of the first signal is equal to or higher than the set value, and to operate the second processing means alone when the level of the first signal is lower than the set value.

In a second aspect, the present invention provides an optical power measuring apparatus for measuring a power level of an optical signal comprised of a light intensity modulated signal, received by a light receiving element, wherein the apparatus comprises:

first output means for outputting a first signal having a voltage which is proportional to a current flowing through the light receiving element;

second output means for outputting a second signal having a voltage which is obtained by converting the current flowing through the light receiving element thereto by a transimpedance amplifier;

first processing means for receiving the first signal and calculating an optical power level corresponding to the first signal;

second processing means for receiving the second signal and calculating an optical power level corresponding to the second signal; and

selecting means for receiving the second signal, comparing the level of the second signal with a predetermined set value, and selecting the output of the first processing means when the level of the second signal is equal to or higher than the set value, and the output of the second processing means when the level of the second signal is lower than the set value to output the selected output as a measured optical power value.

Preferably, in the optical power measuring apparatus described above, the selecting means is further adapted to operate the first processing means alone when the level of the second signal is equal to or higher than the set value, and to operate the second processing means alone when the level of the second signal is lower than the set value.

In a third aspect, the present invention provides an optical power measuring apparatus for measuring a power level of an optical signal comprised of a light intensity modulated signal, received by a light receiving element, wherein the apparatus comprises:

first output means for outputting a first signal having a voltage which is proportional to a current flowing through the light receiving element;

second output means for outputting a second signal having a voltage which is obtained by converting the current flowing through the light receiving element thereto by a transimpedance amplifier;

first processing means for receiving the first signal and calculating an optical power level corresponding to the first signal;

second processing means for receiving the second signal and calculating an optical power level corresponding to the second signal; and

selecting means for selecting the optical power level calculated by the first processing means when the optical power level is equal to or higher than a predetermined set value, and the optical power level calculated by the second processing means when the optical power level calculated by the first processing means is lower than the predetermined set value to output the selected optical power level as a measured optical power value.

In a fourth aspect, the present invention provides an optical power measuring apparatus for measuring a power level of an optical signal comprised of a light intensity modulated signal, received by a light receiving element, wherein the apparatus comprises:

first output means for outputting a first signal having a voltage which is proportional to a current flowing through the light receiving element;

second output means for outputting a second signal having a voltage which is obtained by converting the current flowing through the light receiving element thereto by a transimpedance amplifier;

first processing means for receiving the first signal and calculating an optical power level corresponding to the first signal;

second processing means for receiving the second signal and calculating an optical power level corresponding to the second signal; and

selecting means for selecting the optical power level calculated by the second processing means when the optical power level is lower than a predetermined set value, and the optical power level calculated by the first processing means when the optical power level calculated by the second processing means is equal to or higher than the predetermined set value to output the selected optical power level as a measured optical power value.

Preferably, the optical power measuring apparatus according to the first to fourth aspects of the present invention further comprises temperature detection means for detecting the temperature of the optical power measuring apparatus, and temperature compensating means for compensating the measured optical power value output from the selecting means for the temperature based on a detected temperature.

Also preferably, the first and second processing means comprise first and second tables for converting the first and second signals to optical power levels, respectively, and the temperature compensating means comprises a third table for calibrating the measured optical power value depending on the temperature. Further preferably, the optical signal received by the light receiving element is a light intensity modulated signal in accordance with a digital video transmission standard or an analog video signal.

Preferably, in the optical power measuring apparatus according to the first to fourth aspects of the present invention, the first output means comprises a smoothing circuit, the optical power measuring apparatus further comprises a DC detection circuit connected between the second output means and the second processing means for executing an envelope detection, and the smoothing circuit and the DC detection circuit supply the first and second signals to the first and second processing means, respectively, as DC signals. Also preferably, the optical power measuring apparatus comprises a first analog-to-digital converter connected between the first output means and the first processing means, and a second analog-to-digital converter connected between the second output means and the second processing means, wherein the first and second analog-to-digital converters supply the first and second signals of a digital version to the first and second processing means, respectively.

Further, in a fifth aspect, the present invention provides an optical signal receiving apparatus for receiving, at a light receiving element thereof, an optical signal comprised of a light intensity modulated signal, and outputting an electric signal corresponding to the light signal, wherein the optical signal receiving apparatus comprises an optical power measuring apparatus according to any of the first and fourth aspect as above, and the electric signal corresponding to the optical signal is outputted as an output or an inverted output of the transimpedance amplifier included in the second output means of the optical power measuring apparatus.

Preferably, the optical signal receiving apparatus further comprises display means for receiving the electric signal from the transimpedance amplifier and for displaying a waveform of the electric signal, wherein the display means is further adapted to display an optical power value measured by the optical power measuring apparatus. The display means is preferably a waveform monitor or a readout oscilloscope.

Since the optical power measuring apparatus of the present invention is configured as described above, the dynamic range can be extended for measuring the power of a light intensity modulated signal, thus making it possible to provide a detected voltage which is in a linear relationship with optical power with reduced errors from a large optical power range to a small optical power range. Further, the present invention can reduce the size and cost of the optical power measuring apparatus which can measure the power of a received optical signal while serving as an optical signal receiving apparatus.

### BRIEF DESCRIPTION OF THE DRAWINGS

FIG. 1 is a graph representing a general relationship between a power level of an optical signal applied to a photo-diode and a current flowing through the photo-diode;

FIG. 2 is a diagram generally illustrating an optical signal receiving apparatus which comprises an optical power measuring apparatus, according to the present invention;

FIG. 3A is a graph representing a relationship between a power level of an optical signal received by a photo-diode (PD) 1 and a voltage signal E-mon1 applied from an amplifier circuit 5 to a processor 9 in the apparatus illustrated in FIG. 2, wherein the graph is equivalent to the relationship illustrated in FIG. 1;

FIG. 3B is a graph representing a temperature characteristic of the relationship shown in the graph of FIG. 3A;

FIG. 4A is a graph representing a relationship between the power level of the optical signal received by the PD 1 and a voltage signal E-mon2 applied from an amplifier circuit 7 to the processor 9 in the apparatus illustrated in FIG. 2;

FIG. 4B is a graph representing a temperature characteristic of the relationship shown in the graph of FIG. 4A;

FIG. 5 is a flowchart illustrating an operation executed by the processor 9 of the apparatus illustrated in FIG. 2 according to one embodiment;

FIG. 6 is a flowchart illustrating an operation executed by the processor 9 of the apparatus illustrated in FIG. 2, according to another embodiment; and

FIG. 7 is a graph representing a relationship between the power level of an optical signal applied to the PD and a current flowing through the PD of the apparatus in FIG. 2, which has been obtained as a result of a test using the apparatus.

### DETAILED DESCRIPTION OF EMBODIMENTS

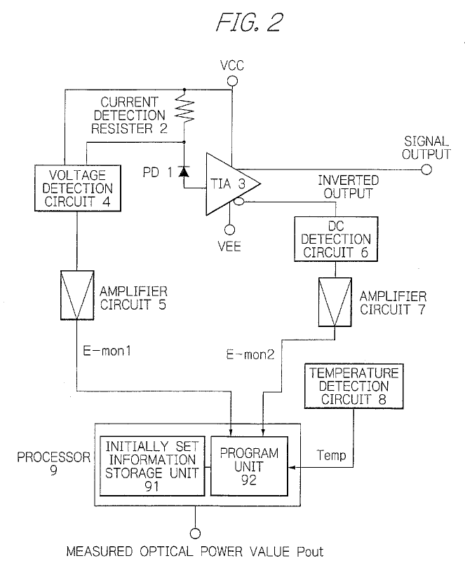

FIG. 2 is a block diagram illustrating an embodiment of an optical power measuring apparatus according to the present invention. In FIG. 2, the numeral 1 denotes a photo-diode (PD), which forms a part of a light receiver of a photo-coupler, receives a light intensity modulated signal. The light intensity modulated signal is based on a digital video transmission standard, for example, SD-SDI (Standard Definition Serial Digital Interface), HD-SDI (High Definition Serial Digital Interface), DVB-ASI (Digital Video Broadcasting-Asynchronous Serial Interface) signal, or the like. The numeral 2 denotes a current detecting resistor having a known resistance, which is connected between a power supply VCC and the PD 1 for extracting a voltage proportional to a current which flows through the PD 1. The numeral 3 denotes a transimpedance amplifier (TIA), which outputs a voltage corresponding to the current flowing through the PD 1 from the power supply VCC, and has a signal output terminal OUT which is a non-inverting output terminal, and an inverting output terminal OUT*. The signal output terminal OUT of the TIA 3 is used to output the voltage signal corresponding to the optical signal received by the PD 1 to an external circuit device(s). Any arbitrary external circuit device(s) may be connected to the signal output terminal OUT of the optical power measuring apparatus, including, for example, a waveform monitoring device, such as a waveform monitor, a readout oscilloscope or the like. In addition, such a waveform monitoring device may be connected to receive an output of a processor 9 of the optical power measuring apparatus, to display an optical power level which is obtained by the processor 9. An operation of the processor 9 will be described later.

The optical power measuring apparatus further comprises a voltage detection circuit 4 and an amplifier 5. The voltage detection circuit 4 comprises a smoothing circuit for smoothing a voltage across the current detection resistor 2 to output a DC voltage corresponding to the current flowing through the PD 1. The amplifier circuit 5 amplifies the output of the voltage detection circuit 4. Alternatively, the voltage detection circuit 4 may be replaced with a current detector (restoring) circuit for restoring the same current as (or proportional to) the current flowing through the current detecting resistor 2 based on a voltage drop of the resistor 2, and the amplifier circuit 5 may be replaced with a circuit for outputting a voltage proportional to the current provided from the current detector.

The optical power measuring apparatus further comprises a DC detection circuit 6 and an amplifier circuit 7. The DC detection circuit 6 performs a DC-detection of the output at the inverting output terminal OUT* of the TIA 3, and the amplifier circuit 7 amplifies the output of the DC detection circuit 6. The inverting output terminal OUT* may be used to output a signal to an external circuit device, while the output of the non-inverting output terminal OUT may be supplied to the DC detection circuit 6, as required. The DC detection circuit 6 detects average values or peak values of the output from the terminal TIA 3 and smoothes or filters them to output a DC voltage corresponding to a power level of an input optical signal (or an inputted light intensity modulated signal). In this regard, the DC detection circuit 6 is preferably configured to perform an envelop detection rather than a peak to peak detection. This is because the former can induce errors in the output DC voltage due to a difference in modulation degree.

The optical power measuring apparatus 100 preferably comprises a temperature detection circuit 8 for outputting a voltage corresponding to the temperature of the apparatus 100.

The processor 9, which comprises a CPU, receives the voltage signals E-mon1 and E-mon2 as monitoring signals from the amplifier circuits 5 and 7, respectively, and a temperature signal Temp from the temperature detection circuit 8, and computes a measured optical power level Pout on the basis of the received signals.

The processor 9 comprises an analog-to-digital (A/D) conversion function executed by a computer program unit, which converts the voltage signals in an analog form applied from the amplifier circuits 5 and 7 and the temperature detection circuit 8 to digital signals. Alternatively, the A/D converters may be disposed at appropriate locations to apply the processor 9 with signals in a digital form, without providing the A/D conversion function in the processor 9. Further alternatively, the voltage detection circuit (smoothing circuit) 4 and DC detection circuit 6 may be removed from the optical power measuring apparatus, and instead thereto, the voltage across the current detection resistor 2 and the voltage outputted at the inverting output OUT* of the TIA 3 may be sampled by A/D converters for conversion to digital signals which are then applied to the processor 9, where the DC signals in a digital form are obtained from the applied digital signals.

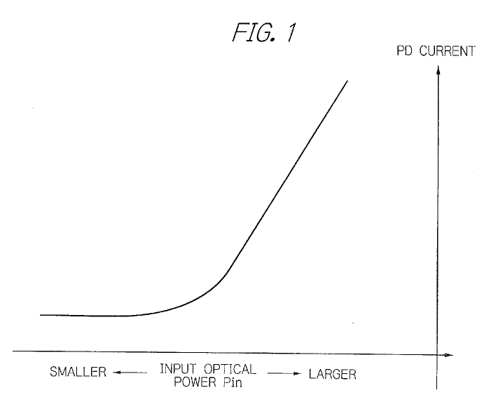

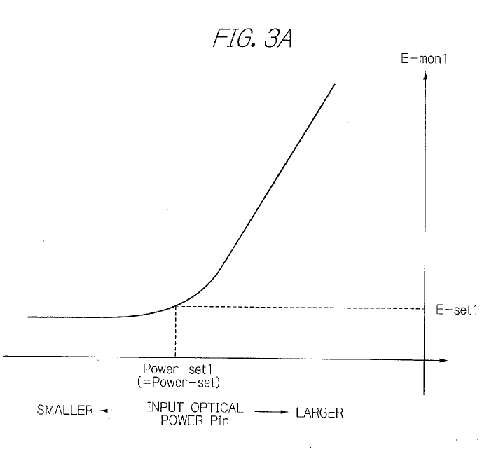

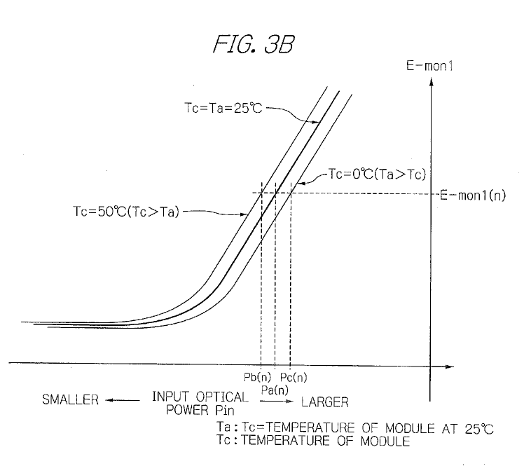

FIG. 3A is a graph schematically representing a relationship between the levels of the power Pin of an optical signal applied to the PD 1 and the voltage signal E-mon1 outputted from the amplifier circuit 5. As described above, the output of the amplifier circuit 5 is in a proportional relationship to the current flowing through the PD 1, so that the graph in FIG. 3A is substantially identical to the graph in FIG. 1 which represents the general relationship between an optical power Pin applied to a PD and a current flowing through the PD.

FIG. 3B represents a temperature characteristic (temperature dependence) of the relationship between the input optical power Pin and the signal E-mon1 shown in the graph in FIG. 3A, where a bold solid line represents the relationship when the temperature Tc is equal to a room temperature Ta, i.e., 25° C. (Tc=Ta=25° C.); a thin solid line when the temperature Tc is higher than 25° C. (Tc>Ta); and a dotted line when the temperature Tc is lower than 25° C. (Tc<Ta).

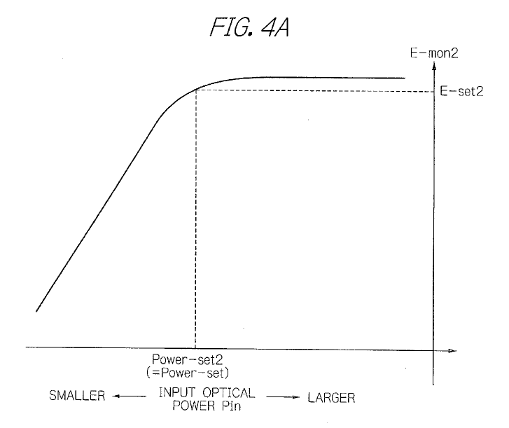

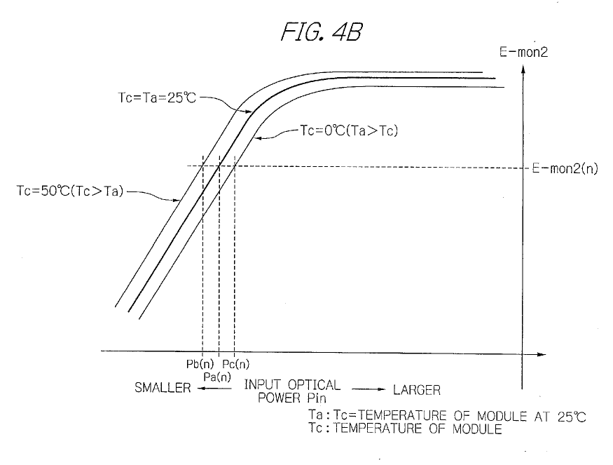

FIG. 4A is a graph schematically representing a relationship between the power Pin of the optical signal applied to the PD 1 and the voltage signal E-mon2 generated from the amplifier circuit 7. As described above, the signal E-mon2 corresponds to the DC voltage of the output signal of the TIA 3.

FIG. 4B is a graph representing a temperature characteristic of the relationship between the input optical power Pin and the signal E-mon2 shown in the graph in FIG. 4A, where a bold solid line represents the temperature characteristic when the temperature Tc is equal to the room temperature Ta=25° C. (Tc=Ta=25° C.); a thin solid line when the temperature Tc is higher than 25° C. (Tc>Ta); and a dotted line when the temperature Tc is lower than 25° C. (Tc<Ta).

The processor 9 comprises an initially set information storage unit 91 and a program unit 92, as illustrated in FIG. 2. The initially set information storage unit 91 previously stores necessary information on initial settings, applied through an appropriate input means. The initially set information includes a switching point and data in the form of data tables. The tables include first and second data tables and optionally a temperature compensation table.

The first and second data tables are look-up tables for retrieving optical power levels corresponding to the levels of the received voltage signals E-mon1 and E-mon2, on the basis of the functions represented by the graphs in FIGS. 3A and 4A, respectively.

The switching point is either a predetermined voltage value or a predetermined optical power value, which is used to determine whether the optical power value is retrieved from the first data table or the second data table. In the case where the switching point is a predetermined voltage value E-set, it is set equal to E-set1 in FIG. 3A (or E-set2 in FIG. 4A), and an optical power level is retrieved from the first data table (or the second data table). In this case, when the signal E-mon1 (or the signal E-mon2) is equal to or higher (or lower) than the voltage value E-set1 (or E-set2), the optical power value retrieved from the first data table (or the second data table) is used as a measured optical power value Pout. On the other hand, when the signal E-mon1 (or the signal E-mon2) is lower (or equal to or higher) than the voltage value E-set1 (or E-set2), the optical power value retrieved from the second data table (or the first data table) is used as a measured optical power value Pout. In the case where the switching point is a predetermined optical power value Power-set, it is set equal to Power-set1 in FIG. 3A and to Power-set2 in FIG. 4A (Power-set=Power-set1=Power-set2). In this case, when a power value Power-mon1 retrieved from the first data table (or Power-mon2 retrieved from the second data table) is equal to or larger than the predetermined power value Power-set, the power value Power-mon1 from the first data table is used as a measured optical power value Pout. On the other hand, when a power value Power-mon1 (or Power-mon2) is smaller than the predetermined power value Power-set, the power value Power-mon2 from the second data table is used as a measured optical power value Pout.

The temperature compensation table is a look-up table which has stored such temperature characteristics as illustrated in FIGS. 3B and 4B, and is used to compensate the optical power values retrieved from the first and second data tables for variations due to the temperature (module temperature) of the optical power measuring apparatus illustrated in FIG. 2, in response to the temperature signal Temp from the temperature detection circuit 8.

The following table shows data of the temperature compensation table, with reference to the temperature characteristics shown in FIGS. 3B and 4B. The table can be created based on actually measured temperature characteristics. The table shows correction or compensation values which should be added or subtracted to an optical power level obtained at 0° C. and 50° C. When a measured temperature is the room temperature of 25° C., the correction value is zero. When the signal Temp indicates a temperature other than those, a compensation or correction value to be added or subtracted to an obtained optical power value, may be set through interpolation. Alternatively, compensation values at predetermined temperatures including 0° C. and 50° C. and other temperatures may be stored in a temperature compensation table as required.

TABLE 1

| Measured Optical | | | |
|---|---|---|---|
| Power Value | Correction Value | | |
| P | 0(° C.) | 25(° C.) | 50(° C.) |
| P(1) | Pa(1) − Pc(1) | 0 | Pa(1) − Pb(1) |
| P(2) | Pa(2) − Pc(2) | 0 | Pa(2) − Pb(2) |
| P(3) | Pa(3) − Pc(3) | 0 | Pa(3) − Pb(3) |
| P(4) | Pa(4) − Pc(4) | 0 | Pa(4) − Pb(4) |
| P(5) | Pa(5) − Pc(5) | 0 | Pa(5) − Pb(5) |
| . | . | . | . |
| . | . | . | . |
| . | . | . | . |
| P(n) | Pa(n) − Pc(n) | 0 | Pa(n) − Pb(n) |

A measured optical power value at a temperature is obtained using the following equation:

Measured Optical Power Value=[Power-mon1(or Power-mon2)]+[Correction Value]

The above-mentioned initially set information is previously obtained by actually testing the optical signal receiving apparatus illustrated in FIG. 2, and is previously stored in the initially set information storage unit 91 of the processor 9. The actual-use test involves acquiring the signals E-mon1, E-mon2 output from the amplifier circuits 5 and 7, respectively, while changing the power of the optical signal, to establish correlations as shown in FIGS. 3A and 4A. Then, the first and second data tables corresponding to these correlations are created. Also, inclinations of these correlation functions are calculated, and the switching point is set at a point at which the inclinations of the correlation functions reverse in magnitude. The temperature compensation table is also created by conducting an actual-use test, where the temperature is varied within a temperature range assumed in possible environments in which the apparatus will be used.

The actual-use test and the storage of the initially set information may be performed upon shipment of the optical signal receiving apparatus from a factory, or may be performed when the optical signal receiving apparatus is initially used, whenever deemed as appropriate. In the latter case, it may be possible that a plurality of sets of the initially set information, i.e., the first data table, second data table, switching point, and temperature compensation table have been previously stored in the initially set information storage unit 91, and an the operator determines which information set in the storage unit 91 should be selected, based on appropriate data samples which can be acquired during the actual-use conducted when the apparatus is in service.

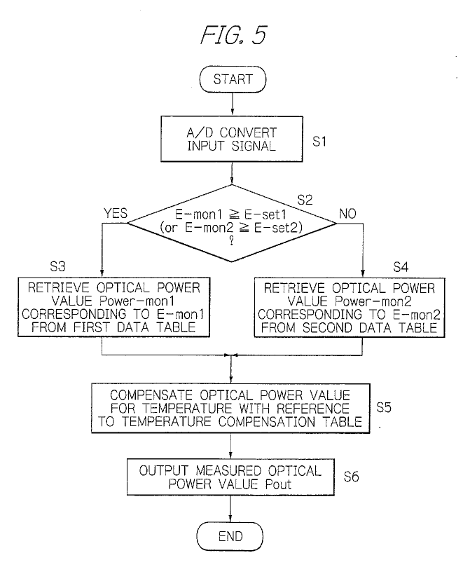

A process executed by the program unit 92 of the processor 9 will be described below with reference to a flowchart shown in FIG. 5. It should be assumed that the initially set information has been previously stored in the initially set information storage unit 91.

As the PD 1 is irradiated with an input optical signal, the amplifier circuits 5 and 7 generate signals Emon1 and Emon2, respectively, in accordance with the power level of the optical signal, as represented by the graphs of FIGS. 3A and 4A. The signals Emon1 and Emon2 are inputted to the processor 9. Also, the temperature detection circuit 8 applies a temperature signal Temp to the processor 9. At Step S1, the processor 9 converts these analog signals to digital signals. In the following description, the digital signals are also designated by the same reference numerals as the analog signals.

Next, at Step S2, the program unit 92 determines whether the signal E-mon1 is equal to or higher than the set voltage E-set1 which is the switching point previously stored in the initially set information storage unit 91. When the signal E-mon2 is used instead of the signal E-mon1, the program unit 92 determines whether E-mon2 is equal to or higher than the set voltage E-set2. When the result of the determination is affirmative or YES, the process flow goes to Step S3, where the program unit 92 retrieves an optical power value Power-mon1 corresponding to the signal E-mon1 with reference to the first data table. On the other hand, when the determination at Step S2 is negative or NO, the flow goes to Step S4, where the program unit 92 retrieves an optical power value Power-mon2 corresponding to the signal E-mon2 with reference to the second data table. When the set voltage E-set2 is previously stored in the initially set information storage unit 91 as the switching point, the determination at Step S2 is made as to whether the signal E-mon2 is equal to or higher than the set voltage E-set2, in which case, the flow goes to Step S3 when the determination is affirmative, and to Step S4 when it is negative.

Subsequently, at Step S5, the program unit 92 compensates the optical power value Power-mon1 or Power-mon2 retrieved at Step S3 or S4 for the temperature using the optical power value and the signal Temp representative of the temperature, with reference to the temperature compensation table. Then, at Step S6, the program unit 92 outputs the digital optical power value, or after converting it to an analog optical power value if required, to a monitor or the like as a measured optical power value Pout.

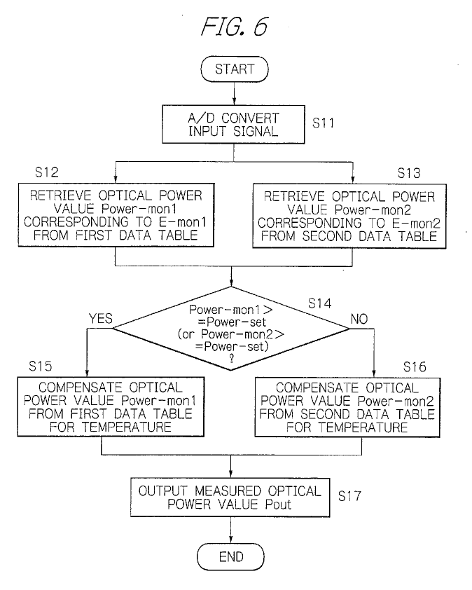

In the example described above, the switching point is set to be a predetermined voltage value for comparison with the signal E-mon1 or E-mon2. Alternatively, the switching point may be set to a predetermined optical power value for comparison with the optical power retrieved from the first or second data table. In this event, the program unit 92 in the processor 9 executes a process as illustrated in a flowchart illustrated in FIG. 6.

After A/D-converting an input signal at Step S11, the program unit 92 executes both Steps S12 and S13 to search the first table for an optical power value corresponding to E-mon1, and to search the second table for an optical value corresponding to E-mon2. Next, at Step S14, the program unit 92 compares the optical power value retrieved from the first data table with the set optical power value Power-set. When the retrieved optical power value is equal to or larger than the set optical power value, the program module 92 compensates the optical power value retrieved from the first data table, with regard to the temperature at Step S15. On the other hand, when the retrieve optical power value is smaller than the set optical power value, the program unit 92 compensates the optical power value retrieved from the second data table, with regard to temperature at Step S16. Then, the program unit 92 outputs the temperature compensated optical power value obtained at Step S15 or S16, as the measured optical power value Pout at Step S17.

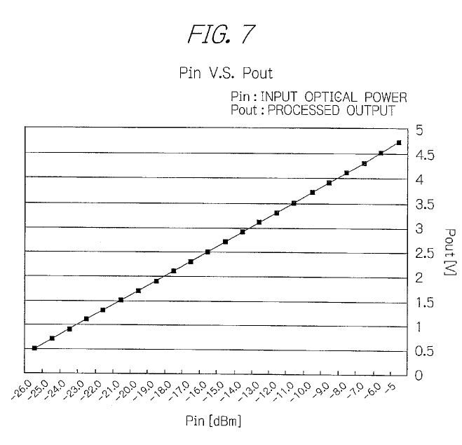

FIG. 7 shows the result of a measurement when an actual-use test was conducted using the optical power measuring apparatus according to the present invention, in which the PD 1 was irradiated with an optical signal including a variety of known power levels. In FIG. 7, the horizontal axis represents the input optical power Pin, while the vertical axis represents an optical power value outputted from the processor 9, i.e., the measured power value Pout. As shown in FIG. 7, the output voltage can be derived in a linear relationship with the optical power over a wide range. Accordingly, the present invention can increase the dynamic range of optical power measurement.

Also, according to the present invention, as an optical signal is received by the receiving apparatus, its power level can be measured, yet without the need for using a beam splitter or the like. Particularly, when a waveform monitoring device such as a waveform monitor, a readout oscilloscope or the like is connected to the output OUT of the TIA 3 to display a waveform of an incoming optical signal thereon, and to the output of the processor 9 to display as an optical power value Pout thereon, the waveform and power value of the received optical signal can be monitored on the single device. It should be understood that the optical power measuring apparatus may be incorporated in a device such as a waveform monitoring device or the like.

Having described specific embodiments of the invention, it is believed obvious that modification and variation of the invention is possible in light of the above teachings.

What is claimed is:

1. An optical power measuring apparatus for measuring a power level of an optical signal comprised of a light intensity modulated signal, received by a light receiving element, the optical power measuring apparatus comprising:
first output means for outputting a first signal having a voltage which is proportional to a current flowing through the light receiving element;
second output means for outputting a second signal having a voltage which is obtained by converting the current flowing through the light receiving element thereto by a transimpedance amplifier;
first processing means for receiving the first signal and calculating an optical power level corresponding to the first signal;
second processing means for receiving the second signal and calculating an optical power level corresponding to the second signal; and
selecting means for receiving the first signal, comparing the level of the first signal with a predetermined set value, and selecting the output of the first processing means when the level of the first signal is equal to or higher than the set value, and the output of the second processing means when the level of the first signal is lower than the set value to output the selected output as a measured optical power value.

2. An optical power measuring apparatus according to claim 1, wherein the selecting means is further adapted to operate the first processing means alone when the level of the first signal is equal to or higher than the set value, and to operate the second processing means alone when the level of the first signal is lower than the set value.

3. An optical power measuring apparatus for measuring a power level of an optical signal comprised of a light intensity modulated signal, received by a light receiving element, the optical power measuring apparatus comprising:
first output means for outputting a first signal having a voltage which is proportional to a current flowing through the light receiving element;
second output means for outputting a second signal having a voltage which is obtained by converting the current flowing through the light receiving element thereto by a transimpedance amplifier;
first processing means for receiving the first signal and calculating an optical power level corresponding to the first signal;
second processing means for receiving the second signal and calculating an optical power level corresponding to the second signal; and
selecting means for receiving the second signal, comparing the level of the second signal with a predetermined set value, and selecting the output of the first processing means when the level of the second signal is equal to or higher than the set value, and the output of the second processing means when the level of the second signal is lower than the set value to output the selected output as a measured optical power value.

4. An optical power measuring apparatus according to claim 3, wherein the selecting means is further adapted to operate the first processing means alone when the level of the second signal is equal to or higher than the set value, and to operate the second processing means alone when the level of the second signal is lower than the set value.

5. An optical power measuring apparatus for measuring a power level of an optical signal comprised of a light intensity modulated signal, received by a light receiving element, the optical power measuring apparatus comprising:
first output means for outputting a first signal having a voltage which is proportional to a current flowing through the light receiving element;
second output means for outputting a second signal having a voltage which is obtained by converting the current flowing through the light receiving element thereto by a transimpedance amplifier;
first processing means for receiving the first signal and calculating an optical power level corresponding to the first signal;
second processing means for receiving the second signal and calculating an optical power level corresponding to the second signal; and
selecting means for selecting the optical power level calculated by the first processing means when the optical power level is equal to or higher than a predetermined set value, and the optical power level calculated by the second processing means when the optical power level calculated by the first processing means is lower than the predetermined set value to output the selected optical power level as a measured optical power value.

6. An optical power measuring apparatus for measuring a power level of an optical signal comprised of a light intensity modulated signal, received by a light receiving element, the optical power measuring apparatus comprising:
first output means for outputting a first signal having a voltage which is proportional to a current flowing through the light receiving element;
second output means for outputting a second signal having a voltage which is obtained by converting the current flowing through the light receiving element thereto by a transimpedance amplifier;
first processing means for receiving the first signal and calculating an optical power level corresponding to the first signal;
second processing means for receiving the second signal and calculating an optical power level corresponding to the second signal; and
selecting means for selecting the optical power level calculated by the second processing means when the optical power level is lower than a predetermined set value, and the optical power level calculated by the first processing means when the optical power level calculated by the second processing means is equal to or higher than the predetermined set value to output the selected optical power level as a measured optical power value.

7. An optical power measuring apparatus according to claim 1, further comprising:
temperature detection means for detecting a temperature of the optical power measuring apparatus; and
temperature compensation means for compensating the measured optical power value outputted from the selecting means for the temperature, based on the detected temperature.

8. An optical power measuring apparatus according to claim 1, wherein the first and second processing means comprise first and second tables for converting the first and second signals to optical power levels, respectively.

9. An optical power measuring apparatus according to claim 7, wherein
the first and second processing means comprise first and second tables for converting the first and second signals to optical power levels, respectively; and
the temperature compensating means comprises a third table for calibrating the measured optical power value depending on the measured temperature.

10. An optical power measuring apparatus according to claim 1, wherein the optical signal received by the light receiving element is a light intensity modulated signal in accordance with a digital video transmission standard.

11. An optical power measuring apparatus according to claim 1, wherein the optical signal received by the light receiving element is an analog video signal.

12. An optical power measuring apparatus according to claim 1, wherein
the first output means comprises a smoothing circuit,
the optical power measuring apparatus further comprises a DC detection circuit connected between the second output means and the second processing means for executing an envelope detection, and
the smoothing circuit and the DC detection circuit supply the first and second signals to the first and second processing means, respectively, as DC signals.

13. An optical power measuring apparatus according to claim 1, further comprising:
a first analog-to-digital converter connected between the first output means and the first processing means; and
a second analog-to-digital converter connected between the second output means and the second processing means,
wherein the first and second analog-to-digital converters supply the first and second signals of a digital version to the first and second processing means, respectively.

14. An optical signal receiving apparatus for receiving, at a light receiving element thereof, an optical signal comprised of a light intensity modulated signal, and outputting an electric signal corresponding to the light signal, wherein the optical signal receiving apparatus comprises an optical power measuring apparatus according to any one of claims 1 to 13, and the electric signal corresponding to the optical signal is outputted as an output or an inverted output of the transimpedance amplifier included in the second output means of the optical power measuring apparatus.

15. An optical signal receiving apparatus according to claim 14, further comprising:
display means for receiving the electric signal from the transimpedance amplifier and for displaying a waveform of the electric signal, wherein the display means is further adapted to display an optical power value measured by the optical power measuring apparatus.

16. An optical signal receiving apparatus according to claim 15, wherein the display means is a waveform monitor or a readout oscilloscope.
